(19) United States
(12) Patent Application Publication
(10) Pub. No.: US 2024/0175994 A1
(43) Pub. Date: May 30, 2024

(54) RANGING SYSTEM AND NON-TRANSITORY RECORDING MEDIUM

(71) Applicant: Naoki Shinoda, Kyoto (JP)

(72) Inventor: Naoki Shinoda, Kyoto (JP)

(73) Assignee: Ricoh Company, Ltd., Tokyo (JP)

(21) Appl. No.: 18/515,775

(22) Filed: Nov. 21, 2023

(30) Foreign Application Priority Data
Nov. 30, 2022 (JP) 2022-191983
Oct. 30, 2023 (JP) 2023-186009

(51) Int. Cl. G01S 7/4861; G01S 7/481; G01S 7/4865; G01S 7/497

(52) U.S. Cl. CPC G01S 7/4861; G01S 7/4816; G01S 7/4865; G01S 7/497

(57) ABSTRACT

A ranging system includes a light projector to project projection light, multiple light-receiving elements to receive light including reflected light of the projection light reflected from an object, and circuitry. Each of the multiple light-receiving elements has a light incident range including an overlapping region overlapping the light incident range of another one of the multiple light-receiving elements. The number of multiple light-receiving elements is three or more, and the number of overlapping regions is two or more. The circuitry outputs distance information based on outputs from the multiple light-receiving elements, and corrects the distance information using outputs from light-receiving areas of the multiple light-receiving elements corresponding to the at least two overlapping regions.

### CROSS-REFERENCE TO RELATED APPLICATIONS

This patent application is based on and claims priority pursuant to 35 U.S.C. §119(a) to Japanese Patent Application No. 2022-191983, filed on Nov. 30, 2022, and 2023-186009, filed on Oct. 30, 2023, in the Japan Patent Office, the entire disclosure of which is hereby incorporated by reference herein.

### BACKGROUND

### Technical Field

Embodiments of the present disclosure relate to a ranging system and a non-transitory recording medium.

### Related Art

In the related art, a ranging system, a ranging apparatus, and a ranging method employing a time-of-flight (ToF) method are known. The ToF method is a method for measuring the distance to an object based on the time from when light is projected to when the reflection light is received.

Further, in the related art, a composite reception and emission apparatus that includes multiple first-type devices and multiple second-type devices is known. In this apparatus, multiple light-receiving units such as the multiple second-type devices are arranged such that the measurement range of each of the light-receiving units overlaps the measurement range of the adjacent light-receiving unit. This apparatus corrects a deviation occurring in the measurement range when measuring the distance to an object based on the output from the multiple light-receiving units.

### SUMMARY

According to one aspect of the present disclosure, a ranging system includes a light projector to project projection light, multiple light-receiving elements to receive light including reflected light of the projection light reflected from an object, and circuitry. Each of the multiple light-receiving elements has a light incident range including an overlapping region overlapping the light incident range of another one of the multiple light-receiving elements. The number of multiple light-receiving elements is three or more, and the number of overlapping regions is two or more. The circuitry outputs distance information based on outputs from the multiple light-receiving elements, and corrects the distance information using outputs from light-receiving areas of the multiple light-receiving elements corresponding to the at least two overlapping regions.

According to another aspect of the present disclosure, a ranging system includes a light projector to project projection light, multiple light-receiving elements to receive light including reflected light of the projection light reflected from an object, a temperature sensor, and circuitry. Each of the multiple light-receiving elements has a light incident range including an overlapping region overlapping the light incident range of another one of the multiple light-receiving elements. The temperature sensor to measures temperature of at least one of the multiple light-receiving elements and outputs temperature information indicating the temperature of at least one of the multiple light-receiving elements. The circuitry outputs distance information based on output from the multiple light-receiving elements, and corrects the distance information using the temperature information and outputs from light-receiving areas of the multiple light-receiving elements corresponding to the overlapping region.

According to another aspect of the present disclosure, a non-transitory recording medium stores a plurality of program codes which, when executed by one or more processors, causes the one or more processors to perform a method. The method includes receiving outputs from three or more light-receiving elements receiving light reflected from an object. Each of the three or more light-receiving elements has a light incident range including an overlapping region overlapping the light incident range of another one of the multiple light-receiving elements. The three or more light-receiving elements have at least two overlapping regions. The method further includes outputting distance information based on outputs from the three or more light-receiving elements; and correcting the distance information using outputs from light-receiving areas of the three or more light-receiving elements corresponding to the overlapping regions.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is an external perspective view of a ranging device according to a first embodiment of the present disclosure;

FIGS. 2A and 2B are diagrams each illustrating a schematic configuration of the ranging device according to the first embodiment;

FIG. 3 is a diagram illustrating a layout of an optical system of the ranging device according to the first embodiment;

FIG. 4 is a block diagram illustrating a hardware configuration of the ranging device according to the first embodiment;

FIG. 5 is a block diagram illustrating a functional configuration of the ranging device according to the first embodiment;

FIG. 6 is a diagram illustrating a distance measuring process performed by the ranging device according to the first embodiment;

FIG. 7 is a schematic diagram illustrating relative positions between the angle of view of time-of-flight (ToF) sensors of the ranging device and measured objects, according to the first embodiment;

FIG. 8 is a diagram illustrating range images each acquired using one of the ToF sensors of the ranging device according to the first embodiment;

FIG. 9 is a block diagram illustrating a functional configuration of a ranging device according to a second embodiment of the present disclosure;

FIG. 10 is a block diagram illustrating a functional configuration of a ranging system according to a third embodiment of the present disclosure; and

FIG. 11 is a schematic diagram illustrating relative positions between the angle of view of ToF sensors of the ranging device and measured objects, according to the third embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below with reference to the drawings. In the drawings, like reference signs are allocated to components having the same or similar configuration, and redundant descriptions may be omitted. As used herein, the singular forms “a,” “an,” and “the” are intended to include the plural forms as well, unless the context clearly indicates otherwise.

### First Embodiment

### Overall Configuration

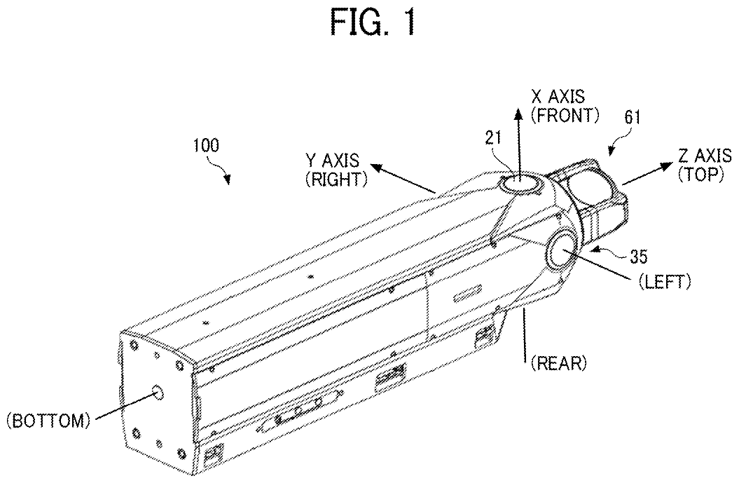

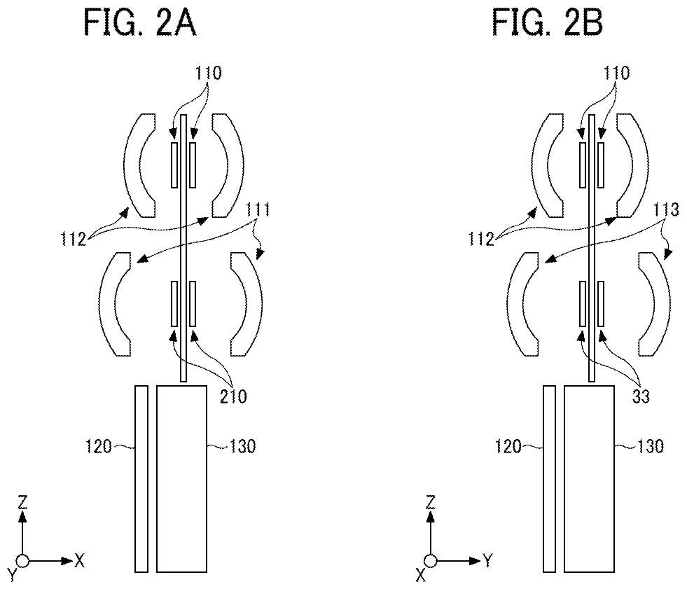

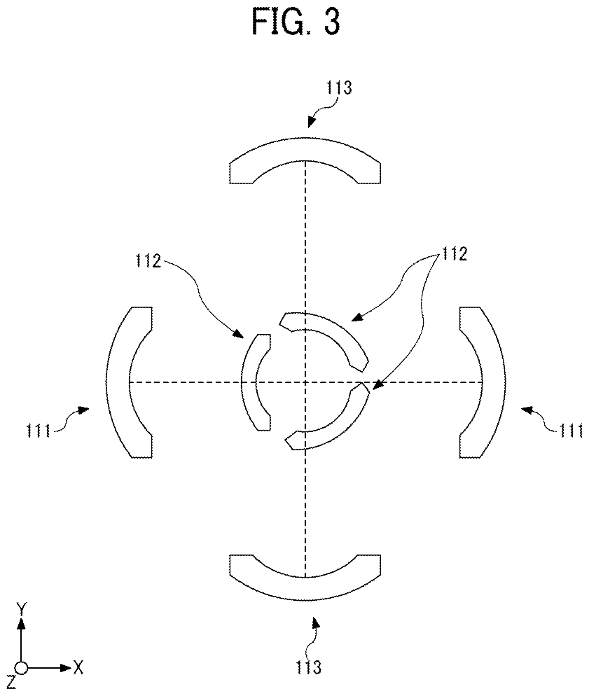

A description is given below of a configuration of an image-capturing device serving as a ranging system according to a first embodiment of the present disclosure, with reference to FIGS. 1 to 3. FIG. 1 is an external perspective view of an image-capturing device 100 according to the first embodiment of the present disclosure. FIGS. 2A and 2B are diagrams each illustrating schematic configurations of the image-capturing device 100. FIG. 3 is a diagram illustrating a layout of an optical system of the image-capturing device 100 according to the first embodiment.

In the present embodiment, the image-capturing device 100 has a ToF ranging function (distance-measuring function) and a function as a luminance camera. A luminance camera is a red-green-blue (RGB) camera or a monochrome camera. The image-capturing device 100 can capture a spherical image (omnidirectional image). The following description is focused on the distance-measuring function of the image-capturing device 100, and the “image-capturing device 100” may be referred to as a “ranging device.”

As illustrated in FIGS. 1 and 2, the image-capturing device (ranging device) 100 includes projector units 21. ToF light-receiving units 61, a luminance light-receiving unit 35, and a circuit board. The projector units 21 and the ToF light-receiving units 61 together serve as a ToF ranging device. In other words, the projector units 21 and the ToF light-receiving units 61 function as a ToF camera. The luminance light-receiving unit 35 functions as a luminance camera.

The projector units 21 emit light (such as infrared light) for distance measuring toward a target region for distance measuring. The projector units 21 each include a light source 210 that emits infrared light and a ToF light projection system 111 (projection optical system) including an optical element that widens the divergence angle. The ToF light projection system 111 includes an optical element to widen the angle of light emitted from the light source 210.

The ToF light projection system 111 illustrated in FIGS. 2A, 2B, and 3 includes optical elements such as a lens, a diffractive optical element (DOE), and a diffusion plate. The light source 210 is, for example, a two-dimensional array of vertical-cavity surface-emitting lasers (VCSELs). The image-capturing device (ranging device) 100 of the present embodiment includes two projector units 21 facing in opposite directions.

The light for distance measuring, emitted from the projector unit 21, is reflected from an object (measured object) in the target region for distance measuring. The ToF light-receiving unit 61 receives the reflected light from the object in the target region for distance measuring. The ToF light-receiving unit 61 includes ToF sensors 110 having the sensitivity to the light for distance measuring, and ToF light-receiving optical systems 112 (first light-receiving optical system). The ToF light-receiving optical systems 112 include optical elements to guide incident light to the ToF sensor 110.

The optical elements of the ToF light-receiving optical system 112 illustrated in FIGS. 2A, 2B, and 3 include a lens. In contrast, the ToF sensor 110 is a light-receiving element such as a complementary metal oxide semiconductor (CMOS) imaging element, in which light-receiving pixels are arranged in a two-dimensional array. In the ToF sensor 110, pixels correspond to positions in the target region for distance measuring, respectively. Accordingly, the ToF light-receiving unit 61 can receive light from the individual positions in the target region for distance measuring. The image-capturing device (ranging device) 100 of the present embodiment includes four ToF light-receiving units 61 facing in different directions.

The luminance light-receiving unit 35 acquires a two-dimensional image using a CMOS sensor 33. The luminance light-receiving unit 35 includes the CMOS sensor 33 to capture a luminance image (RGB image or monochrome image) and a luminance light-receiving optical system 113 (second light-receiving optical system). The luminance light-receiving optical system 113 includes optical elements to guide incident light to the CMOS sensor 33. The optical elements of the luminance light-receiving optical system 113 include a lens.

The circuit board is for driving or controlling the projector units 21, the ToF light-receiving units 61, and the luminance light-receiving unit 35. The circuit board includes, for example, a CMOS board, a light source board, and a main board, and is connected to the light source 210, the ToF sensor 110, and the CMOS sensor 33 via, for example, a cable. The circuits printed on the circuit board construct a control circuit 120.

The projector unit 21 serves as a light projector that emits projection light. The ToF sensors 110 of the ToF light-receiving unit 61 serve as multiple light-receiving elements to receive light including the reflected light of the projection light reflected from an object.

In the present embodiment, as illustrated in FIGS. 1, 2A, and 2B, the image-capturing device (ranging device) 100 is long in the Z-axis direction. The image-capturing device 100 has a first stage at the end in the +Z direction (top end) of the image-capturing device (ranging device) 100. The first stage includes four ToF light-receiving optical systems 112 each having an angle of view of 120 degrees or greater. The four ToF light-receiving optical systems 112 are disposed facing in three directions in the XY plane and +Z direction.

Further, the image-capturing device (ranging device) 100 has a second stage closer to the upstream end in the +Z direction (lower) than the first stage. As illustrated in FIGS. 2A, 2B, and 3, the second stage includes the two ToF light projection systems 111 and the two luminance light-receiving optical systems 113. The two ToF light projection systems 111 each have an angle of view of 180 degrees or greater, and the two luminance light-receiving optical systems 113 each have an angle of view of 180 degrees or greater. The two ToF light projection systems 111 face in opposite directions (+X direction and −X direction), and the two luminance light-receiving optical systems 113 face in opposite directions (+Y direction and −Y direction).

On the lower stage on the −X side of the image-capturing device (ranging device) 100, the control circuit 120 and a battery 130 are disposed. With this structure, the optical system that covers the spherical range can be compactly arranged, and the ranging device can be compact.

The control circuit 120 controls the timing at which the projector units 21 (light projectors) project light, and detects the light reception by the ToF light-receiving units 61. The control circuit 120 controls the timing of driving the light source 210 to emit light to the target region for distance measuring. Further, the control circuit 120 photoelectrically converts the light received by the ToF sensor 110 and outputs the converted light as an image including information indicating the distance (also referred to as a “range image” in the following description). A “range image” may be referred to as a “distance image.” At the same time, the CMOS sensor 33 captures an image and outputs a luminance image.

In a configuration using a direct ToF sensor as the ToF sensor 110, a range image based on the light reception timing by each pixel is output. By contrast, in a configuration using an indirect ToF sensor as the ToF sensor 110, phase images based on the amounts of light received at four different phases by each pixel is output, which will be described in detail later. from the four phase images, a range image can be generated.

### Hardware Configuration of Ranging Device

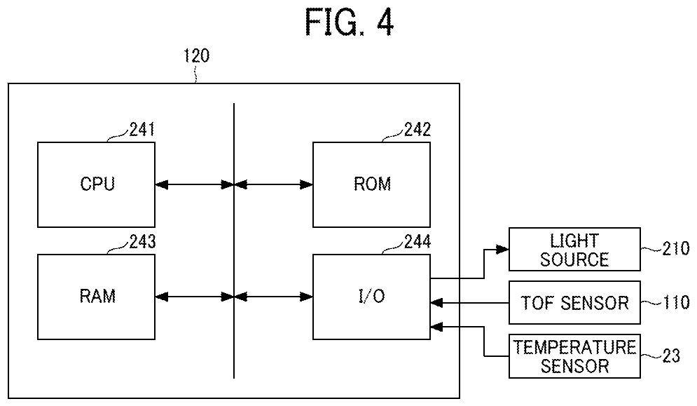

A description is given below of a hardware configuration of the image-capturing device (ranging device) 100 according to the first embodiment, with reference to FIG. 4. FIG. 4 is a block diagram illustrating a hardware configuration of the image-capturing device (ranging device) 100 according to the first embodiment. As illustrated in FIG. 4, the control circuit 120 of the image-capturing device (ranging device) 100 according to the present embodiment includes a central processing unit (CPU) 241, a read-only memory (ROM) 242, a random-access memory (RAM) 243, and an input/output (I/O) port 244.

The CPU 241 is a processor that executes programs stored in a recording medium such as the ROM 242 to sequentially execute, for example, processing of branch and repetition. The ROM 242 is a non-volatile storage device that stores, for example, the programs and data executed by the CPU 241. The RAM 243 is a memory that is used as, for example, a work area of the CPU 241. The I/O port 244 is an interface for inputting and outputting of various signals. These components are connected via a bus. The programs may be stored in a recording medium other than the ROM 242. Examples of the recording medium include a flexible disk, a hard disk, a compact disc read-only memory (CD-ROM), a magneto-optical disc (MO), a digital versatile disk (DVD)-ROM, and a memory card. The programs may be downloaded to the ROM 242 via a communication network. The control circuit 120 of the image-capturing device (ranging device) 100 serves as a “computer.”

### Functional Configuration of Ranging Device

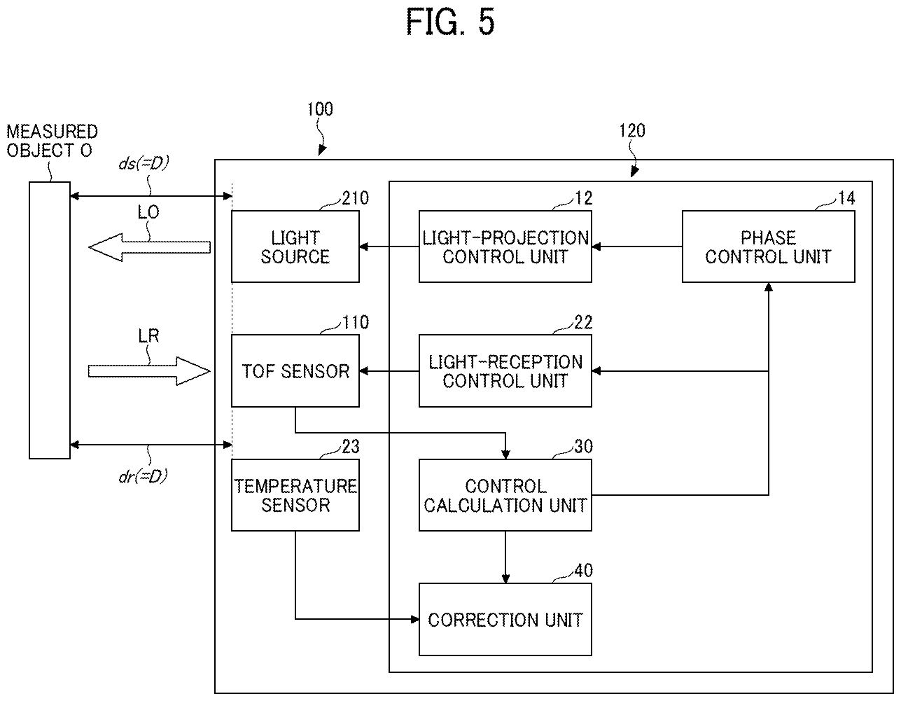

A description is given below of a functional configuration of the image-capturing device (ranging device) 100 according to the first embodiment, with reference to FIG. 5. FIG. 5 is a block diagram illustrating a functional configuration of the image-capturing device (ranging device) 100 according to the first embodiment. The image-capturing device (ranging device) 100 executes the above-described program to execute various processes and steps for implementing the following functions.

As illustrated in FIG. 5, the image-capturing device (ranging device) 100 includes the light source 210, the ToF sensor 110, a temperature sensor 23, and the control circuit 120. The control circuit 120 controls the various operations of the light source 210 and the ToF sensor 110. The control circuit 120 includes a light-projection control unit 12, a phase control unit 14, a light-reception control unit 22, a control calculation unit 30, and a correction unit 40.

The light-projection control unit 12 controls the driving of the light source 210 to project the distance-measuring light LO at a desired time point. The light-projection control unit 12 outputs, to the light source 210, the light projection timing and information indicating, for example, the modulation frequency, the exposure time, and the number of repetitions of the distance-measuring light LO. The light source 210 emits the distance-measuring light LO to a measured object O based on the information output from the light-projection control unit 12. The light-projection control unit 12 of the present embodiment is implemented by, for example, the CPU 241 that executes a program.

The light-reception control unit 22 controls the timing at which the ToF sensor 110 receives light LR reflected from the measured object O. The ToF sensor 110 has a light-receiving sensor surface provided with multiple charge accumulation windows. The light-reception control unit 22 outputs, to the ToF sensor 110, the timing for individually controlling the opening and closing of each charge accumulation window, and the reflected light LR is received based on this timing. The ToF sensor 110 accumulates charges corresponding to the reflected light received at the timing of opening and closing the individual charge accumulation windows. The light-reception control unit 22 of the present embodiment is implemented by, for example, the CPU 241.

The ToF sensor 110 outputs, to the control calculation unit 30, information on the amount of accumulated charge corresponding to the received light LR, per charge accumulation window. Receiving the information on the amount of accumulated charge per charge accumulation window, the control calculation unit 30 performs computing for distance measuring. In other words, the control calculation unit 30 calculates distance information of the measured object O based on the output from the ToF sensor 110. The control calculation unit 30 serves as a distance measuring unit.” The control calculation unit 30 of the present embodiment is implemented by, for example, the CPU 241.

The temperature sensor 23 is disposed near the ToF sensor 110 and detects temperature at the time of distance measuring by the ToF sensor 110. Examples of the temperature sensor 23 include various types of temperature sensor such as a thermistor.

The correction unit 40 corrects the distance information of the measured object O calculated by the control calculation unit 30. For example, the correction unit 40 may acquire changes in the measured distance value with respect to temperature as a function or table information in advance, and correct the distance information using the temperature information of the ToF sensor 110 output from the temperature sensor 23 at the time of distance measuring. The correction unit 40, however, may correct the distance information based on information other than the temperature information of the ToF sensor 110 at the time of distance measuring. The correction unit 40 of the present embodiment is implemented by, for example, the CPU 241. Further, in a case where the image-capturing device (ranging device) 100 includes a direct ToF sensor as the ToF sensor 110, the light reception timing (light reception time) calculated based on the output from the ToF sensor 110 is corrected.

The phase control unit 14 controls the phase by shifting the light emission timing of the light source 210 via the light-projection control unit 12. The phase control unit 14 of the present embodiment is implemented by, for example, the CPU 241.

### Distance Measuring Process

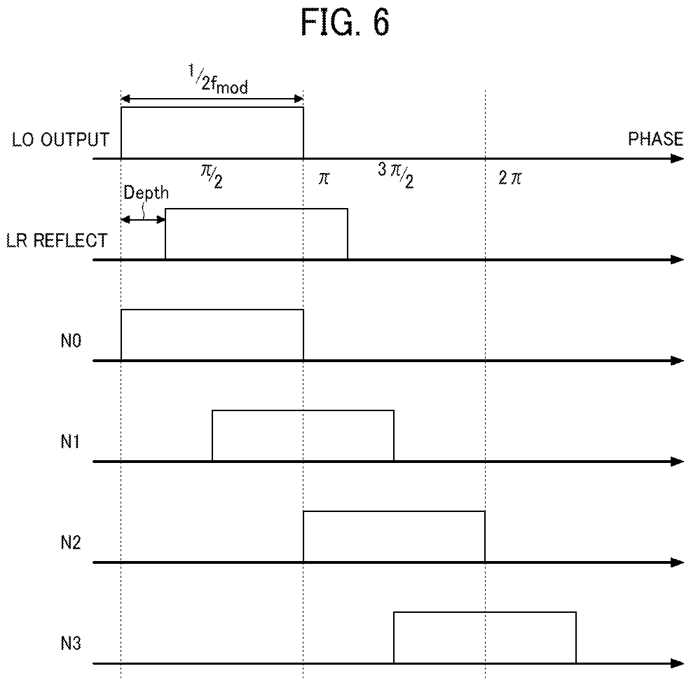

A description is given below of a distance measuring process performed by the image-capturing device (ranging device) 100 according to the first embodiment, with reference to FIG. 6. FIG. 6 is a diagram illustrating a distance measuring process performed by the image-capturing device (ranging device) 100 according to the first embodiment. Initially, a description is given of a distance measurement process performed by the image-capturing device (ranging device) 100 on the assumption that changes in the distance-measuring light LO have an ideal rectangular shape. The distance measuring process performed by the image-capturing device (ranging device) 100 of the present embodiment employs an indirect ToF method. However, the distance measuring process is not limited to that employing the indirect ToF method, and a direct ToF method may be employed.

As illustrated in FIG. 6, in the distance measuring process of the image-capturing device (ranging device) 100, the reflected light LR is sampled by charge storage by opening and closing four charge accumulation windows. On the top line “output” in FIG. 6, the pulse width of the distance-measuring light LO is illustrated. The distance-measuring light LO has a pulse width π and is projected with a phase 0. The pulse width of the distance-measuring light LO is determined by a modulation frequency f_{mod} output from the light-projection control unit 12.

On the second line “reflect” in FIG. 6, the pulse width of the reflected light LR reflected from the measured object O is illustrated. The reflected light LR has a rectangular shape according to the changes in the distance-measuring light LO. The reflected light LR has a pulse width π.

The opening and closing timing of the first charge accumulation window NO is illustrated in the line “N0” of FIG. 6. The opening and closing timing of the second charge accumulation window N1 is illustrated in the line “N1” of FIG. 6. The opening and closing timing of the third charge accumulation window N2 is illustrated in the line “N2” of FIG. 6. The opening and closing timing of the fourth charge accumulation window N3 is illustrated in the line “N3” of FIG. 6.

The “Depth” illustrated in FIG. 6 represents the phase difference corresponding to the time interval from when the distance-measuring light LO is emitted to when the ToF sensor 110 starts receiving the reflected light LR reflected from the measured object O. The distance to be measured is a “distance corresponding to a ½ phase difference” of the phase difference corresponding to the phase difference “depth.” The light-receiving surface of the ToF sensor 110 has the four charge accumulation windows N0, N1, N2, and N3, which sequentially open and close at the respective timings output from the light-reception control unit 22 and accumulate charges corresponding to the amount of the received light. Specifically, in the distance measuring process employing the ToF method, based on a time difference τ_{d} to when the distance-measuring light LO is reflected from the measured object O, Equation 1 presented below is established when c represents the light speed, ds represents the distance from the light source 210 to the measured object O, dr represents the distance from the measured object O to the ToF sensor 110, d the represents the total distance.

d=(ds+dr)=cτ_{d} Equation 1

In the indirect ToF method used in the distance measuring process according to the present embodiment, the time difference τ_{d} is not directly measured, but the distance is calculated from a phase difference φ between the output signal from the light source 210 and a light-receiving signal.

Since the ToF sensor 110 detects the distance traveled by the distance-measuring light LO emitted from the light source 210, the total distance d that is the measurement result is twice the “distance D from the device to a measured object O” in a typical device. It is assumed that the light source 210 and the ToF sensor 110 are located at symmetrical positions such that the distance ds from the light source 210 to the measured object O is considered to be equal to the distance dr from the measured object O to the ToF sensor 110 (ds=dr).

In this case, from Equation 2, Equation 3 is derived.

d=2D=(c/2πf_{mod})×φ Equation 2

D=(c/4πf_{mod})×φ Equation 3

When the reflected light RL from the measured object O reaches the light-receiving surface of the ToF sensor 110, the ToF sensor 110 accumulates the charges corresponding to the intensity of the reflected light RL received in the time of the corresponding phase by the opening and closing of the charge accumulation windows. Specifically, the charge accumulation window N0 opens simultaneously with the start of emission of the distance-measuring light LO, so as to accumulate the charges to the phase π. Similarly, the charge accumulation window N1 opens to accumulate the charges from the phase π/2 to the phase 3π/2. The charge accumulation window N2 opens to accumulate the charges from the phase π to the phase 2π. The charge accumulation window N3 opens to accumulate the charges due to light reception from the phases 3π/2 to 5π/2.

In other words, the timings at which the charge accumulation windows open and close are shifted in four stages with a phase difference of π/2. The distance D corresponding to the phase difference Depth is obtained by Equation 4 below by the discrete Fourier transform. In Equation 4, n0, n1, n2, and n3 represent the amounts of charges accumulated in the opening times of the charge accumulation windows N0, N1, N2, and N3, respectively.

D=(1/4πf_{mod})×arctan{(n1−n3)/(n0−n2)} Equation 4

### Principle of Correction

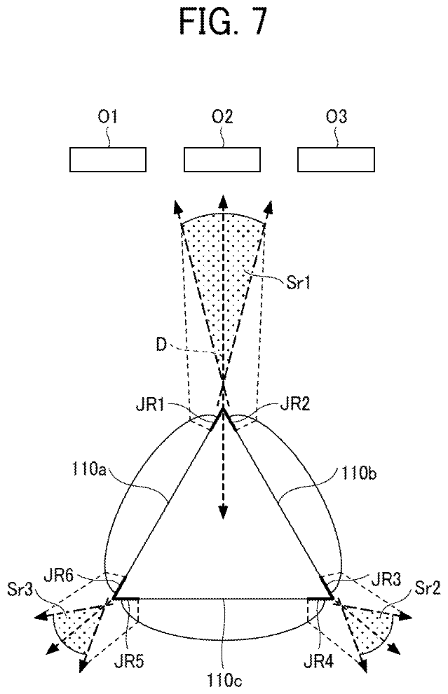

A description is given below of a principle of correction of distance information in the first embodiment. When describing the principle of correction, FIG. 7 is referred to as appropriate. FIG. 7 is a schematic diagram illustrating relative positions between the angle of view of the ToF sensors 110 and measured objects according to the present embodiment.

As illustrated in FIG. 7, the image-capturing device (ranging device) 100 of the present embodiment includes multiple ToF sensors 110 (110a, 110b, and 110c). The ToF sensors 110a, 110b, and 110c are arranged facing in three directions different from each other by, for example, 120 degrees, and a 360-degree angle of view is achieved as a whole. The ToF sensor 110a serves as a “first light-receiving element.” The ToF sensor 110b serves as a “second light-receiving element.” The ToF sensor 110c serves as a “third light-receiving element.” Further, the ToF sensors 110a, 110b, and 110c are arranged such that the angle of view of the ToF sensor 110a and that of the ToF sensor 110b overlap in an overlapping region Sr1, the angle of view of the ToF sensor 110b and that of the ToF sensor 110c overlap in an overlapping region Sr2, and the angle of view of the ToF sensor 110c and that of the ToF sensor 110a overlap in an overlapping region Sr3. Portions of the two-dimensional arrays of light-receiving pixels of the ToF sensors 110a. 110b, and 110c are light-receiving areas JR1, JR2, and JR3 corresponding to the overlapping regions Sr1, Sr2, and Sr3, respectively. In other words, each of the ToF sensors 110 has a light-receiving area such that the light incident range of the ToF sensors 110 overlaps the light incident range of another ToF sensors 110.

The overlapping region Sr1 serves as a “first overlapping region.” The overlapping region Sr2 serves as a “second overlapping region.” The overlapping region Sr3 serves as a “third overlapping region.” The overlapping region Sr1, the overlapping region Sr2, and the overlapping region Sr3 are collectively referred to as “overlapping regions Sr.” The light-receiving area JR1 illustrated in FIG. 7 corresponds to the overlapping region Sr1 of the ToF sensor 110a. The light-receiving area JR2 corresponds to the overlapping region Sr1 of the ToF sensor 110b. The light-receiving area JR3 corresponds to the overlapping region Sr2 of the ToF sensor 110b. The light-receiving area JR4 corresponds to the overlapping region Sr2 of the ToF sensor 110c. The light-receiving area JR5 corresponds to the overlapping region Sr3 of the ToF sensor 110c. The light-receiving area JR6 corresponds to the overlapping region Sr3 of the ToF sensor 110a. The light-receiving areas JR1, JR2, JR3, JR4, JR5, and JR6 are collectively referred to as “light-receiving areas JR corresponding to the overlapping regions Sr.”

The distance D is determined by the respective charge amounts of the charge accumulation windows and the trigonometric ratio. However, the measured distance value (distance information) D_{act} that is actually measured using the ToF sensor 110 can be modeled by the following equation using a true distance (true value) D and an error term D′.

D_{act}=D+D′ Equation 5

The error term D′ is generated from various factors such as the temperature and the individual difference of the ToF sensor 110. Among such error terms, the error term D′ caused by temperature changes depends on the environment at the time of use, and has a large influence on the measured distance value. Accordingly, the error term D′ is described as an error based on temperature in the following description.

As illustrated in FIG. 7, the measured objects O1 and O2 are disposed to be included in the angle of view of the ToF sensor 110a (included in the incident range of detectable light). The measured objects O2 and O3 are disposed to be included in the angle of view of the ToF sensor 110b. The measured object O2 is included in the overlapping region Sr1. The ToF sensors 110 output at least the results of light received in the light-receiving areas corresponding to the overlapping regions, and the measured distance value is calculated from such output results.

At this time, the measured distance values measured using the ToF sensor 110a and the ToF sensor 110b are as follows. The distance measurement values presented below are on the assumption that each ToF sensor 110 outputs the light reception result of the entire sensor region including the region outside the overlapping region.

D_{act}11=D1+D1′ Equation 6

D_{act}12=D2+D1′ Equation 7

D_{act}22=D2+D2′ Equation 8

D_{act}23=D3+D2′ Equation 9

In Equation 6 above, D_{act}11 represents the measured distance value obtained by measuring the measured object O1 using the ToF sensor 110a. D_{act}12 represents the measured distance value obtained by measuring the measured object O2 using the ToF sensor 110a. D_{act}22 represents the measured distance value obtained by measuring the measured object O2 using the ToF sensor 110b. D_{act}23 represents the measured distance value obtained by measuring the measured object O3 using the ToF sensor 110b. D1 to D3 represent the ideal measured distance values of the measured objects 1 to 3. D1′ represents the temperature error term of the ToF sensor 110a. D2′ represents the temperature error term of the ToF sensor 110b. The temperature error terms D1′, D2′, and D3′ of the ToF sensors 110a, 110b, and 110c may be collectively referred to as “temperature error terms D”' in the following description.

Attention is paid to the measured object O2 included in the angle of view of the ToF sensor 110a and that of the ToF sensor 110b adjacent to the ToF sensor 110a. Since D2 is equal in Equations 7 and 8 above, Equation 9 below is obtained.

D_{act}12−D1′=D_{act}22−D2′ Equation 9

By transforming Equation 9, Equation 10 is obtained.

D_{act}12=D_{act}22+D1′−D2′ Equation 10

According to Equation 10, if the temperature error terms D1′ and D2′ of the ToF sensors 110a and 110b are known, the measured distance value obtained by the ToF sensor 110b can be corrected to be equal to the measured distance value obtained by the ToF sensor 110a. By contrast, when none of the temperature error terms D′ is known, the temperature error terms such as D1′ and D2′ may be calculated by, for example, the following method. For example, a pseudo-inverse matrix of a matrix that associates the respective error terms of the ToF sensors 110 with the difference between the measured distance values of the two ToF sensors 110 of the multiple ToF sensors 110 is obtained by an analytical method. Based on the obtained pseudo-inverse matrix, the most probable numerical values of the error terms (such as D1′ and D2′) are obtained.

Further, from Equation 9, Equation 11 can be obtained.

D2′=D_{act}22−D_{act}12+D1′ Equation 11

According to Equation 11, if the temperature error term D1′ of the ToF sensor 110a is known, the temperature error term D2′ of the ToF sensor 110b can be obtained. In other words, for example, the temperature of one (for example, the ToF sensor 110a) of the ToF sensor 110s and the errors of the measured distance values are associated with each other in advance by, for example, a preliminary experiment. Then, for example, a function of temperature and errors of the ToF sensor 110a or a correction table is created. In this way, at the time of distance measuring, errors can be obtained from the temperature of the ToF sensor 110a detected by the temperature sensor 23, and further, errors of another ToF sensor 110 (for example, the ToF sensor 110b) can be obtained using Equation 11 presented above. Then, the measured distance value obtained by using the ToF sensor 110b can be corrected to be equal to the measured distance value obtained by using the ToF sensor 110a by using Equation 10 presented above. Although the description of the principle of correction above relates to the error caused by the temperature, the same applies to errors caused by other factors.

Further, although the description of the principle of correction above relates to the ToF sensor 110a and the ToF sensor 110b, the same applies to the relation between the other ToF sensors 110 (such as the relation between the ToF sensors 110b and 110c, or the relation between the ToF sensors 110c and 110a). For example, similar to Equation 11, an equation of the temperature error term D3′ that includes the temperature error term D2′ is derived from the overlapping region Sr2 of the ToF sensors 110b and 110c. When the temperature error term D1′ is known, the temperature error term D2′ can be obtained by Equation 11. As a result, the temperature error term D3′ can be obtained. In this manner, the error terms D′ of all the ToF sensors 110 can be determined. Further, the use of the result of the overlapping region Sr3 enables the output of a range image in which an error is small as a whole, and continuity is maintained among all the ToF sensors 110. In the present embodiment, the three ToF sensors 110a, 110b, and 110c are used, but the number of the ToF sensors is not limited thereto. Even when four or more ToF sensors 110 are used, if the adjacent ToF sensors 110 have an overlapping region of the angle of view, the error terms D′ of any one of the multiple ToF sensors 110 is known, and the error term D′ of another ToF sensor 110 can be derived therefrom. At this time, preferably, each of the ToF sensors 110 has at least one overlapping region. In other words, preferably, the number of overlapping regions is equal to or greater than the number of the ToF sensors 110 minus 1. When the multiple ToF sensors 110 form an angle of view of 360 degrees as illustrated in FIG. 7, preferably, the number of overlapping regions is equal to or greater than the number of the ToF sensors 110.

In the present embodiment, the multiple objects such as the measured objects O1, O2, and O3 may be measured by arranging the multiple measured objects in the multiple overlapping regions, respectively, and simultaneously performing light projection and reception. Alternatively, the image-capturing device (ranging device) 100 may be rotated using a rotation mechanism. Yet alternatively, the image-capturing device (ranging device) 100 may include a rotation mechanism to rotate the ToF sensors 110 so as to sequentially direct the overlapping regions to the same measured object and perform multiple number of times of light projection and reception.

### Correction of Distance Information

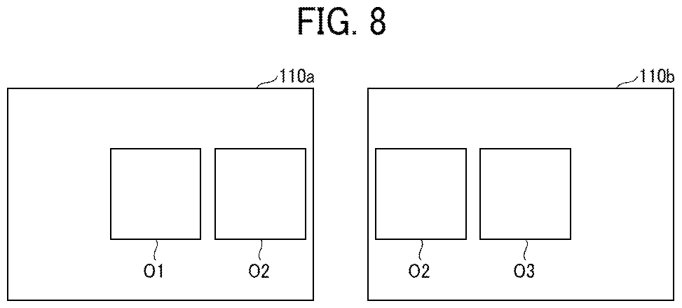

A description is given below of the correction of distance information performed by the image-capturing device (ranging device) 100 of the first embodiment, with reference to FIGS. 7 and 8. FIG. 7 is a schematic diagram illustrating relative positions between the angle of view of the ToF sensors 110 and measured objects according to the present embodiment. FIG. 8 illustrates a range image acquired using the ToF sensor 110a and a range image acquired using the ToF sensor 110b.

As illustrated in FIG. 7, the measured object O2 is included in the overlapping range Sr1 of the angles of view of the adjacent ToF sensors 110a and 110b. At this time, as illustrated in FIG. 8, the measured objects O1 and 2 are included in the range image based on the output of the ToF sensor 110a. As illustrated in FIG. 8, the measured objects O2 and 3 are included in the range image based on the output of the ToF sensor 110b. In other words, the measured object O2 is included in both the range images.

The correction unit 40 of the image-capturing device (ranging device) 100 associates the temperature error of the ToF sensor 110a with that of the ToF sensor 110a by using, for example, Equation 11 presented above, the temperature information in the vicinity of the ToF sensor 110a, output from the temperature sensor 23, and the temperature error of the ToF sensor 110a based on the temperature information. The correction unit 40 corrects the measured distance values using Equation 10 to make the measured distance values of the ToF sensors 110a and 110b equal to each other.

This correction maintains the continuity of the range images based on the outputs of the adjacent ToF sensors 110a and 110b using the overlapping region between the angles of view of the adjacent ToF sensors 110a and 110b. According to the present embodiment, it is not necessary to provide the temperature sensor 23 for all of the multiple ToF sensors 110. Accordingly, the device configuration can be simplified, and the space can be saved.

Typically, errors in the measured distance value of a measured object located in the peripheral region of the angle of view of the ToF sensor 110 are greater than errors in the measured distance value of a measured object located in a central region of the angle of view of the ToF sensor 110. In other words, errors in the measured distance values vary depending on the position of the measured object in the angle of view of the ToF sensor 110. Accordingly, according to the correcting method based on the measured distance value of the measured object positioned in the central region of the angle of view of the ToF sensor 110. the continuity of the range images based on the outputs from the adjacent ToF sensors 110a and 110b may not be maintained in some cases.

In order to avoid such a situation, in the present embodiment, the ranges and positions of the angles of view of the adjacent ToF sensors 110a and 110b are adjusted so that the overlapping region Sr of the angles of view is positioned in the peripheral regions of the angles of view of the adjacent ToF sensors 110a and 110b. As a result, the continuity of the range images based on the outputs of the adjacent ToF sensors 110a and 110b can be maintained.

In order to reduce errors in the measured distance values at the center of the angle of view of the ToF sensor 110 while maintaining the continuity of the range images, correction may be performed using a measured distance value from a measured object having a size ranging from the periphery to the center of the angle of view of the ToF sensor 110. For example, on the assumption that the distance to the measured object does not change from the central to the periphery of the angle of view of ToF sensor 110, correction may be continuously performed from the center to the periphery of the angle of view of ToF sensor 110 such that the measured distance values obtained at different positions of the angle of view matches the measured distance value obtained at the center (lens center) in the central region of the angle of view of ToF sensor 110. As another method, a first measured distance value is obtained with the measured object positioned in the overlapping region. Then, the image-capturing device (ranging device) 100 is rotated without changing the position of the image-capturing device (ranging device) 100, and a second measured distance value is obtained with the measured object positioned in the central portion of the angle of view of the ToF sensor 110. The correction may be performed based on the first and second measured distance values. For example, the average of the measured distance value in the overlapping region and the measured distance value in the central portion of the angle of view of the ToF sensor 110 may be obtained. Alternatively, the measured distance value in the overlapping region may be corrected to be equal to the measured distance value in the central portion of the angle of view of the ToF sensor 110. At this time, the error term D′ in the overlapping region may be determined based on the value in the overlapping region of the angle of view of the ToF sensor 110 serving as a true value. At this time, the ToF sensor 110 may be rotated using, for example, the above-mentioned rotation mechanism to obtain a measured distance value at the peripheral region of the angle of view of the ToF sensor 110 and a measured distance value at the central region.

The image-capturing device (ranging device) 100 may obtain the correction value of the distance information by correcting the distance information in advance before shipment from the factory, or may acquire the correction value of the distance information when used after the shipment. The image-capturing device (ranging device) 100 may obtain the numerical value of the temperature error term (correction value) by multiple number of times of measurements performed under different temperature environments.

### Second Embodiment

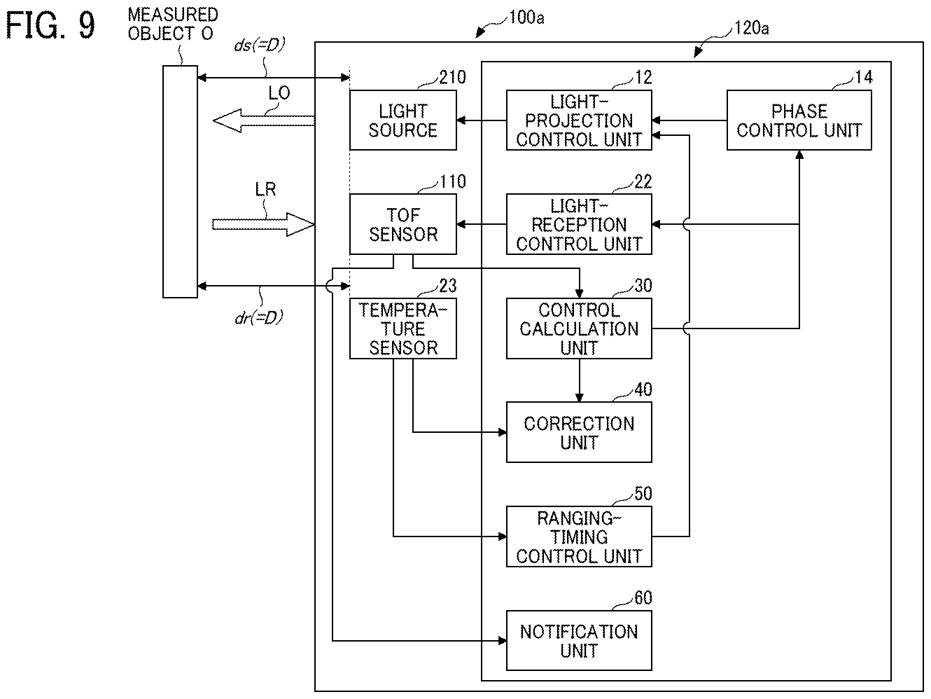

A description is given below of a ranging device of a second embodiment, with reference to FIG. 9. FIG. 9 is a block diagram illustrating a functional configuration of an image-capturing device (ranging device) 100a according to the second embodiment.

As illustrated in FIG. 9, the image-capturing device (ranging device) 100a according to the second embodiment includes a control circuit 120a that further includes a ranging-timing control unit 50 and a notification unit 60, which are implemented by, for example, the CPU 241 executing a program.

the ranging-timing control unit 50 controls the light-projection control unit 12 to perform distance measuring for correcting the distance information in a case where, for example, the temperature of the ToF sensor 110 measured by the temperature sensor 23 is equal to or higher than a threshold value. With the ranging-timing control unit 50, a situation in which the temperature error of the measured distance value increases can be appropriately detected, and the correction with high accuracy can be performed.

In the correction of the distance information, the notification unit 60 notifies a user of a correction error when the distance measuring is not available since the measured object is not located in the overlapping region of the angles of view of the adjacent ToF sensors 110a and 110b. With the notification unit 60, the occurrence of a correction error can be reliably reported to the user.

### Third Embodiment

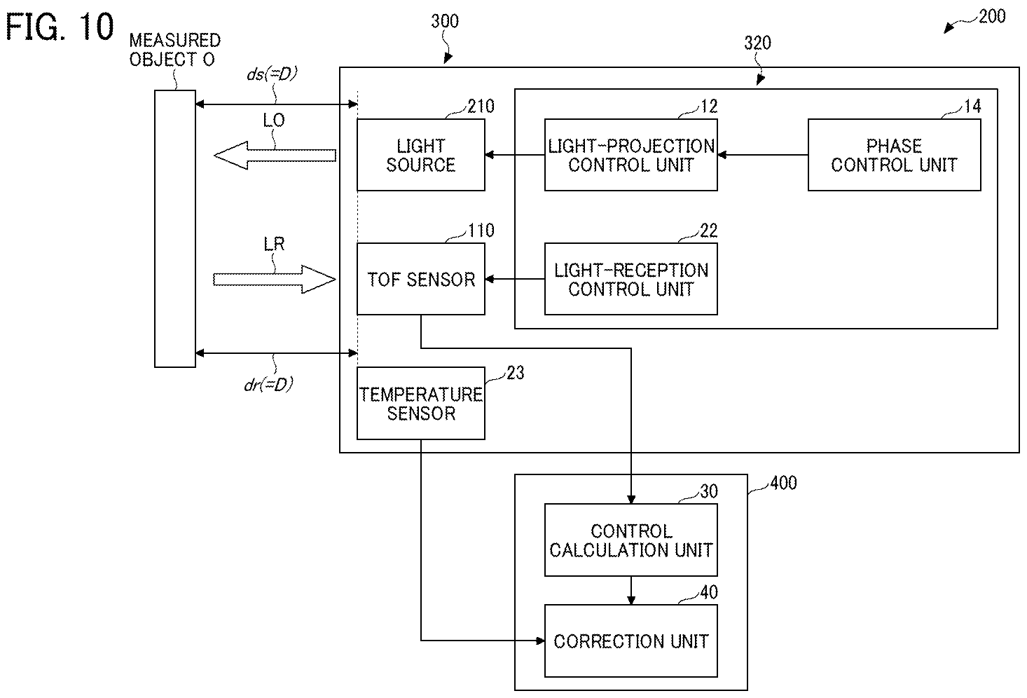

A description is given below of a ranging system of a third embodiment, with reference to FIG. 10. FIG. 10 is a block diagram illustrating a functional configuration of a ranging system 200 according to a third embodiment of the present disclosure.

The functions of the control calculation unit 30 and the correction unit 40 of the present embodiment may be implemented by an information processing apparatus different from a ranging device 300 (e.g., an image-capturing device).

Specifically, as illustrated in FIG. 10, the ranging system 200 includes the ranging device 300 and an information processing apparatus 400. The ranging device 300 includes the light source 210, the ToF sensor 110, the temperature sensor 23, and a control circuit 320. The information processing apparatus 400 includes the control calculation unit 30 and the correction unit 40. The third embodiment is different from the first and second embodiments in that the control calculation unit 30 and the correction unit 40 are included in the information processing apparatus 400 outside the ranging device 300. The information processing apparatus 400 is, for example, a communication terminal such as a personal computer (PC) or a server connected via a network.

The ranging device 300 outputs data such as information on the amount of accumulated charge of the ToF sensor 110 to the information processing apparatus 400. At this time, the data may be directly transmitted from the ranging device 300 to the information processing apparatus 400 by wired or wireless connection, or may be transmitted via a communication terminal (such as a PC) different from the information processing apparatus 400. In addition to the information on the amount of accumulated charge, the temperature information of the ToF sensor 110 from the temperature sensor 23 may be output. The calculation of the distance information and the correction of the distance information are similar to those in the first and second embodiments. Further, the control circuit 320 of the ranging device 300 may include the ranging-timing control unit 50 and the notification unit 60, similar to the control circuit 120a of the second embodiment.

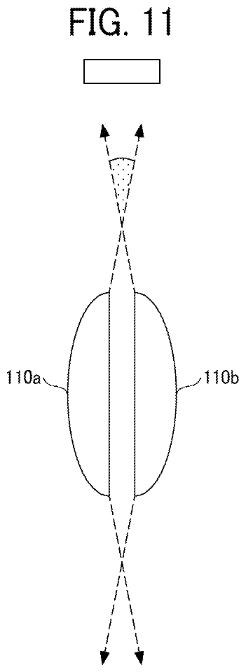

Although some embodiments of the present disclosure are described above, the embodiments of the present disclosure are not limited thereto. The above-decried embodiments may be modified in various manners without departing from the scope of the present disclosure. For example, in the above-described embodiments, the ToF light-receiving optical system 112 employs a four-lens optical system but may employ a two-lens optical system as illustrated in FIG. 11. In the above-described embodiments, the light source 210 projects light in all directions but may scan a space with light narrowed into a beam having a narrow angle. Further, the functions of the control calculation unit (distance measuring unit) 30 and the correction unit 40 may be implemented by an information processing apparatus different from the image-capturing device (ranging device) 100. In this case, the image-capturing device (ranging device) 100 and the information processing apparatus connected to communicate with each other construct a ranging system.

One aspect of the present disclosure achieves a ranging system and a non-transitory recording medium storing a program that enhance the correction accuracy of distance information based on outputs from multiple light-receiving units.

Aspects of the present disclosure are, for example, as follows.

In Aspect 1, a ranging system includes a light projector that projects projection light, multiple light-receiving elements to receive light including reflected light of the projection light reflected from an object, a distance measuring unit that outputs distance information based on an output from the multiple light-receiving elements; and a correction unit to correct the distance information.

A light incident range of each of the multiple light-receiving elements includes an overlapping region overlapping the light incident range of another one of the multiple light-receiving elements. The number of the multiple light-receiving elements is three or greater, and the multiple light-receiving elements have at least two overlapping regions. The correction unit corrects the distance information using the output from the light-receiving area corresponding to the overlapping region of each of the multiple light-receiving elements.

In Aspect 2, in the ranging system according to Aspect 1, the multiple light-receiving elements include a first light-receiving element, a second light-receiving element, and a third light-receiving element, and the multiple light-receiving elements have a first overlapping region in which the light incident range of the first light-receiving element overlaps the light incident range of the and a second light-receiving element, and a second overlapping region in which the light incident range of the second light-receiving element overlaps the light incident range of the third light-receiving element.

The correction unit corrects the distance information based on the output from the first light-receiving element, the second light-receiving element, and the third light-receiving element, using a first output from the light-receiving area of the first light-receiving element corresponding to the first overlapping region, a second output from the light-receiving area of the second light-receiving element corresponding to the first overlapping region, a third output from the light-receiving area of the second light-receiving element corresponding to the second overlapping region, and a fourth output from the light-receiving area of the third light-receiving element corresponding to the second overlapping region.

In Aspect 3, in the ranging system according to Aspect 1 or 2, the multiple light-receiving elements have an angle of view of 360 degrees, and a light incident range of each of the multiple light-receiving elements includes an overlapping region overlapping the light incident range of another one of the multiple light-receiving elements. The number of the overlapping regions is equal to or greater than the number of the multiple light-receiving elements, and the correction unit corrects the distance information using the output from six or greater light-receiving areas each corresponding to the overlapping regions of the multiple light-receiving elements.

In Aspect 4, the ranging system according to any one of Aspects 1 to 3 further includes a temperature measurement unit to measure the temperature of at least one of the multiple light-receiving elements and output temperature information.

In Aspect 5, a ranging system includes a light projector that projects projection light, multiple light-receiving elements to receive light including reflected light of the projection light reflected from an object, a temperature measurement unit to measure the temperature of at least one of the multiple light-receiving elements and output temperature information, a distance measuring unit that outputs distance information based on outputs from the multiple light-receiving elements; and a correction unit to correct the distance information.

Each of the multiple light-receiving elements has an overlapping region in a light incident range, and the overlapping region overlaps the light incident range of another one of the multiple light-receiving elements.

The correction unit corrects the distance information using the temperature information and the output from the light-receiving area corresponding to the overlapping region of each of the multiple light-receiving elements.

In Aspect 6, in the ranging system according to Aspect 4 or 5, the multiple light-receiving elements include a first light-receiving element and a second light-receiving element, and the overlapping region includes a first overlapping region formed by the first light-receiving element and the second light-receiving element.

The temperature measurement unit measures the temperature of the first light-receiving element.

The correction unit corrects the distance information using the temperature information of the first light-receiving element, a first output from the light-receiving area of the first light-receiving element corresponding to the first overlapping region, and a second output from the light-receiving area of the second light-receiving element corresponding to the first overlapping region.

In Aspect 7, the ranging system according to any one of Aspects 4 to 6 further includes a ranging-timing control unit to perform distance measuring for correcting the distance information in a case that the temperature of the light-receiving element is equal to or higher than a threshold temperature.

In Aspect 8, in the ranging system according to any one of 1 to 7, the correction unit corrects the distance information using an output from the light-receiving area corresponding to the overlapping region and an output from a light-receiving area corresponding to a central region of the light incident range closer to a center of the light incident range than the overlapping region.

In Aspect 9, the ranging system according to any one of Aspects 1 to 8 further includes a notification unit to perform notification when the object to be measured is not in the overlapping region.

In Aspect 10, a program causes a computer to execute receiving an output from each of multiple light-receiving elements, outputting distance information based on the output from each of the multiple light-receiving elements, and correcting the distance information.

The number of the multiple light-receiving elements is three or greater, and the multiple light-receiving elements form two or more overlapping regions in each of which a light incident range of one of the multiple light-receiving elements overlaps a light incident range of another light-receiving element. In the receiving, the output from each of the multiple light-receiving elements includes, at least, outputs from light-receiving areas respectively corresponding to the two or more overlapping regions.

In the correcting, the distance information is corrected using the output from the light-receiving area corresponding to the overlapping region of the multiple light-receiving elements.

In Aspect 11, a ranging method includes projecting projection light; receiving light including reflected light of the projection light reflected light from an object, with multiple light-receiving elements; outputting temperature information indicating a measured temperature of at least one of the multiple light-receiving elements; outputting distance information based on the outputs from the multiple light-receiving elements; and correcting the distance information.

In the receiving light, a light incident range of each of the multiple light-receiving elements has an overlapping region overlapping the light incident range of another light-receiving element, and the received light includes the light received by the overlapping region.

In the correcting, the distance information is corrected using the temperature information and the output from the light-receiving area corresponding to the overlapping region of the multiple light-receiving elements.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. A ranging system comprising:
a light projector to project projection light;
multiple light-receiving elements to receive light including reflected light of the projection light reflected from an object, each of the multiple light-receiving elements having a light incident range including an overlapping region, the overlapping region overlapping the light incident range of another one of the multiple light-receiving elements, the multiple light-receiving elements including three or more light-receiving elements and having at least two overlapping regions; and
circuitry configured to:
output distance information based on outputs from the multiple light-receiving elements; and
correct the distance information using outputs from light-receiving areas of the multiple light-receiving elements corresponding to the at least two overlapping regions.

2. The ranging system according to claim 1,
wherein the multiple light-receiving elements include a first light-receiving element, a second light-receiving element, and a third light-receiving element,
wherein the at least two overlapping regions include:
a first overlapping region formed by the first light-receiving element and the second light-receiving element; and
a second overlapping region formed by the second light-receiving element and the third light-receiving element, and
wherein the distance information is based on outputs from the first light-receiving element, the second light-receiving element, and the third light-receiving element, and
wherein the circuitry is configured to correct the distance information using a first output from a light-receiving area corresponding to the first overlapping region of the first light-receiving element, a second output from a light-receiving area corresponding to the first overlapping region of the second light-receiving element, a third output from a light-receiving area corresponding to the second overlapping region of the second light-receiving element, and a fourth output from a light-receiving area corresponding to the second overlapping region of the third light-receiving element.

3. The ranging system according to claim 1,
wherein the multiple light-receiving elements have an angle of view of 360 degrees,
the number of the overlapping regions is equal to or greater than the number of the multiple light-receiving elements, and
wherein the circuitry is configured to correct the distance information using outputs from six or greater light-receiving areas each corresponding to the overlapping regions of the multiple light-receiving elements.

4. The ranging system according to claim 1, further comprising a temperature sensor to measure temperature of at least one of the multiple light-receiving elements and output temperature information indicating the temperature of at least one of the multiple light-receiving elements.

5. A ranging system comprising:
a light projector to project projection light;
multiple light-receiving elements to receive light including reflected light of the projection light reflected from an object, each of the multiple light-receiving elements having a light incident range including an overlapping region, the overlapping region overlapping the light incident range of another one of the multiple light-receiving elements;
a temperature sensor to measure temperature of at least one of the multiple light-receiving elements and output temperature information indicating the temperature of at least one of the multiple light-receiving elements; and
circuitry configured to:
output distance information based on outputs from the multiple light-receiving elements; and
correct the distance information using the temperature information and outputs from light-receiving areas of the multiple light-receiving elements corresponding to the overlapping region.

6. The ranging system according to claim 5,
wherein the multiple light-receiving elements include a first light-receiving element and a second light-receiving element, and the overlapping region includes a first overlapping region formed by the first light-receiving element and the second light-receiving element,
wherein the temperature sensor is to measure temperature of the first light-receiving element, and
wherein the circuitry is configured to correct the distance information using the temperature information of the first light-receiving element, a first output from the light-receiving area of the first light-receiving element corresponding to the first overlapping region, and a second output from the light-receiving area of the second light-receiving element corresponding to the first overlapping region.

7. The ranging system according to claim 5,
wherein the circuitry is further configured to perform distance measuring for correcting the distance information in a case that the temperature information indicates a temperature equal to or higher than a threshold temperature.

8. The ranging system according to claim 1,
wherein the circuitry is configured to correct the distance information using the output from the light-receiving area corresponding to the overlapping region and an output from a light-receiving area corresponding to a central region of the light incident range closer to a center of the light incident range than the overlapping region.

9. The ranging system according to claim 1,
wherein the circuitry is further configured to perform notification in a case that an object to be measured is not present in the overlapping region.

10. A non-transitory recording medium storing a plurality of program codes which, when executed by one or more processors, causes the one or more processors to perform a method, the method comprising:
receiving outputs from three or more light-receiving elements receiving light reflected from an object, each of the three or more light-receiving elements having a light incident range including an overlapping region, the overlapping region overlapping the light incident range of another one of the multiple light-receiving elements, the three or more light-receiving elements having at least two overlapping regions;
outputting distance information based on outputs from the three or more light-receiving elements; and
correcting the distance information using outputs from light-receiving areas of the three or more light-receiving elements corresponding to the at least two overlapping regions.
